(19) United States
(12) Patent Application Publication
(10) Pub. No.: US 2025/0123434 A1
(43) Pub. Date: Apr. 17, 2025

(54) OPTICAL DUAL FABRY-PEROT INTERFEROMETER FILM

(71) Applicant: KYUNGPOOK NATIONAL UNIVERSITY INDUSTRY-ACADEMIC COOPERATION, Daegu (KR)

(72) Inventors: Yun Seon DO, Daegu (KR); Jun Yong KIM, Daegu (KR)

(73) Assignee: KYUNGPOOK NATIONAL UNIVERSITY INDUSTRY-ACADEMIC COOPERATION, Daegu (KR)

(21) Appl. No.: 18/715,528

(22) PCT Filed: Dec. 1, 2022
(86) PCT No.: PCT/KR2022/019324

§ 371 Date: May 31, 2024

(30) Foreign Application Priority Data
Dec. 2, 2021 (KR) 10-2021-0171090

(51) Int. Cl. G02B 5/28

(52) U.S. Cl. CPC G02B 5/285

(57) ABSTRACT

The present invention relates to an optical dual Fabry-Perot interferometer film, and more particularly, to a technology for increasing color purity using a double cavity layer. The optical dual Fabry-Perot interferometer film according to one embodiment of the present invention may include a first anti-reflection layer, a second anti-reflection layer formed on an upper portion of the first anti-reflection layer; and first and second cavity regions formed between the first anti-reflection layer and the second anti-reflection layer.

### TECHNICAL FIELD

The present invention relates to an optical dual Fabry-Perot interferometer film, and more particularly, to a technology for increasing color purity using a double cavity layer.

In addition, the present invention was derived from research conducted as part of the electronic component industry technology development (R&D) project described below.

Information on the national research and development project related to this patent is as follows.

Project Unique Number: 1415173989

Grant Number: 20016350

Ministry in charge of project: Ministry of Trade, Industry and Energy

Specialized institute of research management: Korea Planning & Evaluation Institute of Industrial Technology

Research program: ELECTRONIC COMPONENT INDUSTRY TECHNOLOGY DEVELOPMENT (R&D)

Title of research project: DEVELOPMENT OF ULTRA HIGH QUALITY WITH LONG LIFETIME OF COLOR CONVERTING MATERIAL, PROCESS AND MODULE FOR EXTREMELY LARGE-AREA MICRO LED DISPLAY

Project Implementation Agency: Fine Lab Co., Ltd.

This work was supported by the Technology Innovation Program (20016350, Development of ultra high quality with long lifetime of color converting material, process and module for extremely large-area micro LED display) funded By the Ministry of Trade, Industry & Energy (MOTIE, Korea).

### BACKGROUND ART

Various technologies are being researched to improve the color purity of light extracted externally from optoelectronic devices such as light-emitting devices (OLED, QLED, uLED) or liquid crystal displays. A display using an optoelectronic device can express various colors using the three primary colors (RGB). As the color purity of the three primary colors increases, the color reproduction rate of the display increases, which plays an important role in realizing all colors expressed in reality. To improve the purity of the three primary colors of light extracted externally from an optoelectronic device, various optical films and filters such as surface plasmons composed of photonic crystals, Fabry-Perot interferometers, quantum dots, and hole/dot array patterns are used. To improve the color purity of the three primary colors, the structures of the optical films are different for each of the three primary colors. In the case of a Fabry-Perot interferometer, patterning is required because the thickness of the cavity is different for each of the three primary colors. Accordingly, there are problems that need to be solved in terms of process and cost.

### DISCLOSURE

### Technical Problem

Therefore, the present invention has been made in view of the above problems, and it is one object of the present invention to provide an optical film having high color purity.

It is another object of the present invention to provide an optical film having a double cavity layer.

It is still another object of the present invention to provide an optical film capable of simultaneously increasing the color purity of three primary colors.

It is still another object of the present invention to provide an optical film capable of being manufactured with an easy manufacturing process.

It is still another object of the present invention to provide an optical film capable of being manufactured without a patterning process.

It is yet another object of the present invention to provide an optical film capable of reducing manufacturing costs.

### Technical Solution

In accordance with one aspect of the present invention, provided is an optical dual Fabry-Perot interferometer film including a first anti-reflection layer; a second anti-reflection layer formed on an upper portion of the first anti-reflection layer; and first and second cavity regions formed between the first anti-reflection layer and the second anti-reflection layer.

According to one embodiment, the optical dual Fabry-Perot interferometer film may include a first reflection layer formed on an upper portion of the first anti-reflection layer; a second reflection layer formed on an upper portion of the first reflection layer; and a third reflection layer formed between the second reflection layer and the second anti-reflection layer. The first cavity region may be a first cavity layer formed between the first reflection layer and the second reflection layer, and the second cavity region may be a second cavity layer formed between the second reflection layer and the third reflection layer.

According to one embodiment, the first cavity region may generate primary resonance at a specific wavelength band of light incident on the first cavity region.

According to one embodiment, the second cavity region may generate high-order resonance at a specific wavelength band of light incident on the second cavity region.

According to one embodiment, a resonance order of the high-order resonance in the second cavity region may be determined by a thickness of the second cavity region.

According to one embodiment, depending on a thickness of the first cavity region, a spectral distribution of light transmitted through the optical dual Fabry-Perot interferometer film may be determined.

According to one embodiment, a thickness of the first cavity region may be from 20 nm to 250 nm.

According to one embodiment, peak positions of red, green, and blue resonance wavelengths of light transmitted through the optical dual Fabry-Perot interferometer film and color purity at each may be determined by a thickness of the second cavity region.

According to one embodiment, a thickness of the second cavity layer may be 200 nm to 1000 nm.

According to one embodiment, at least one of the first anti-reflection layer, the second anti-reflection layer, the first cavity region, and the second cavity region may include a dielectric material.

According to one embodiment, the dielectric material may include an inorganic substance or organic substance that is transparent and has low light loss. For example, the dielectric material may be at least one inorganic substance of SiNₓ, Al₂O₃, SiO₂, HfO₂, WO₃, TiO₂, MoO₃, ZnO, Ta₂O₅, V₂O₅, LiF, and ZnS or at least one organic substance of PVP, PVC, PI, PMMA, NPB, TCTA, and TPBi, without being limited thereto.

According to one embodiment, at least one of the first reflection layer, the second reflection layer, and the third reflection layer may be formed as a translucent reflector.

According to one embodiment, the reflector may be formed using a metal thin film.

According to one embodiment, the first reflection layer, the second reflection layer, and the third reflection layer may be a metal thin film having a thickness of 1 nm to 35 nm.

According to one embodiment, the metal thin film may include at least one of gold (Au), silver (Ag), aluminum (Al), tungsten (W), and molybdenum (Mo).

According to one embodiment, the metal thin film may include at least one of alloy materials of gold, silver, and aluminum.

According to one embodiment, optical dual Fabry-Perot interferometer film may further include a substrate formed on an upper portion of the second anti-reflection layer.

According to one embodiment, the substrate may be at least one of transparent substrates such as glass substrates, insulating polymer substrates, and semiconductor substrates.

According to one embodiment, the substrate may be a transparent and flexible substrate.

In accordance with another aspect of the present invention, provided is an optical dual Fabry-Perot interferometer film including a first anti-reflection layer; a first reflection layer formed on an upper portion of the first anti-reflection layer; a second reflection layer formed on an upper portion of the first reflection layer; a first cavity layer formed between the first reflection layer and the second reflection layer; a third reflection layer formed on an upper portion of the second reflection layer; a second cavity layer formed between the second reflection layer and the third reflection layer; and a second anti-reflection layer formed on an upper portion of the third reflection layer.

### Advantageous Effects

According to one aspect of the present invention, the color purity of an optical film can be increased.

In addition, according to another aspect of the present invention, an optical film having a double cavity layer can be provided.

In addition, according to another aspect of the present invention, through one film structure, the color purity of the three primary colors of an optical film can be increased simultaneously.

In addition, according to another aspect of the present invention, an optical film can be manufactured using an easy manufacturing process.

In addition, according to another aspect of the present invention, an optical film can be manufactured without a patterning process.

In addition, according to another aspect of the present invention, the manufacturing costs of an optical film can be reduced.

### DESCRIPTION OF DRAWINGS

FIG. 1 is a diagram showing the structure of an optical dual Fabry-Perot interferometer film according to an embodiment of the present invention.

FIG. 2 is a diagram showing the parameters of an optical dual Fabry-Perot interferometer film according to an embodiment of the present invention.

FIG. 3 is a diagram showing the transmittance of light transmitted to a first cavity layer through a first reflection layer calculated according to an embodiment of the present invention.

FIG. 4 is a diagram showing the Fabry-Perot factor of a first cavity layer and the transmittance of light transmitted to a second cavity layer through a second reflection layer calculated according to an embodiment of the present invention.

FIG. 5 is a diagram showing the Fabry-Perot factor of a second cavity layer and the transmittance of light transmitted to the outside through a third reflection layer calculated according to an embodiment of the present invention.

FIG. 6 is a diagram showing the transmittance of an optical dual Fabry-Perot interferometer film using optical simulation according to an embodiment of the present invention.

FIG. 7 is a diagram showing an example of an optical dual Fabry-Perot interferometer film according to an embodiment of the present invention.

FIG. 8 is a diagram showing another example of an optical dual Fabry-Perot interferometer film according to an embodiment of the present invention.

### BEST MODE

Specific structural and functional descriptions of embodiments according to the concept of the present invention disclosed herein are merely illustrative for the purpose of explaining the embodiments according to the concept of the present invention. Furthermore, the embodiments according to the concept of the present invention can be implemented in various forms and the present invention is not limited to the embodiments described herein.

The embodiments according to the concept of the present invention may be implemented in various forms as various modifications may be made. The embodiments will be described in detail herein with reference to the drawings. However, it should be understood that the present invention is not limited to the embodiments according to the concept of the present invention, but includes changes, equivalents, or alternatives falling within the spirit and scope of the present invention.

It should be understood that, although the terms first, second, third etc. may be used herein to describe various elements, these elements should not be limited by these terms. These terms are only used to distinguish one element from another element. For example, a first element may be termed a second element and a second element may be termed a first element without departing from the teachings of the present invention.

It should be understood that when an element is referred to as being “connected to” or “coupled to” another element, the element may be directly connected or coupled to the other element or intervening elements may be present. In contrast, when an element is referred to as being “directly connected to” or “directly coupled to” another element, there are no intervening elements present. Other words used to describe the relationship between elements or layers should be interpreted in a like fashion (e.g., “between,” versus “directly between,” “adjacent,” versus “directly adjacent,” etc.).

The terms used in the present specification are used to explain a specific exemplary embodiment and not to limit the present inventive concept. Thus, the expression of singularity in the present specification includes the expression of plurality unless clearly specified otherwise in context. Also, terms such as “include” or “comprise” should be construed as denoting that a certain characteristic, number, step, operation, constituent element, component or a combination thereof exists and not as excluding the existence of or a possibility of an addition of one or more other characteristics, numbers, steps, operations, constituent elements, components or combinations thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present invention will be described in detail with reference to the accompanying drawings. However, the scope of the present invention is not limited by these embodiments. Like reference numerals in the drawings denote like elements.

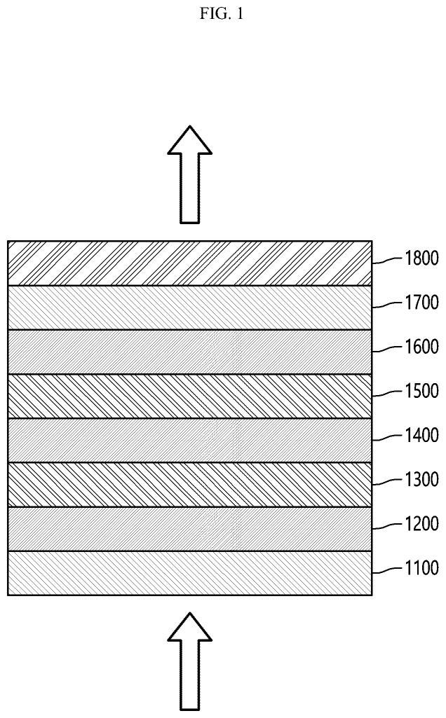

FIG. 1 is a diagram showing the structure of an optical dual Fabry-Perot interferometer film according to an embodiment of the present invention.

Referring to FIG. 1, an optical dual Fabry-Perot interferometer film 1000 may include a first anti-reflection layer 1100, a first reflection layer 1200, a first cavity layer 1300, a second reflection layer 1400, a second cavity layer 1500, a third reflection layer 1600, a second anti-reflection layer 1700, and a substrate 1800.

The first anti-reflection layer 1100 (anti-reflection film 1) may include a dielectric material that is transparent and has low light loss. For example, the dielectric material may include at least one inorganic substance of SiNₓ, Al₂O₃, SiO₂, HfO₂, WO₃, TiO₂, MoO₃, ZnO, Ta₂O₅, V₂O₅, LiF, and ZnS or at least one organic substance of PI, PMMA, NPB, TCTA, and TPBi, without being limited thereto.

According to one embodiment, depending on the thickness of the first anti-reflection layer 1100, the amount of light transmitted through the first anti-reflection layer 1100 to the first cavity layer 1300 may be controlled differently.

The first reflection layer 1200 (reflector 1) may be a translucent metal thin film formed on the upper portion of the first anti-reflection layer 1100, i.e., between the first anti-reflection layer 1100 and the first cavity layer 1300.

According to one embodiment, the first reflection layer may be a metal thin film having a thickness of 1 nm to 35 nm.

According to one embodiment, the metal thin film may include at least one of gold (Au), silver (Ag), aluminum (Al), tungsten (W), and molybdenum (Mo).

According to one embodiment, the metal thin film may include at least one of alloy materials of gold, silver, and aluminum.

The first cavity layer 1300 (active cavity) may be formed on the upper portion of the first reflection layer 1200, i.e., between the first reflection layer 1200 and the second reflection layer 1400.

According to one embodiment, the first cavity layer 1300 may cause a primary resonance phenomenon in a first preset wavelength band. That is, in the first cavity layer 1300, light transmitted through the first anti-reflection layer 1100 to the first cavity layer 1300 is reflected multiple times by the first reflection layer 1200 and the second reflection layer 1400, thereby causing primary resonance. In addition, light in which primary resonance has occurred may be transmitted through the second reflection layer 1400 to the second cavity layer 1500. At this time, the thickness of the first cavity layer 1300 may be adjusted so that primary resonance occurs.

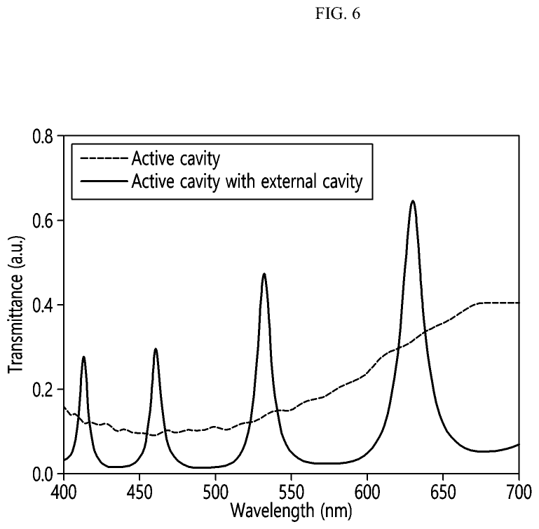

According to one embodiment, the first preset wavelength band may be determined according to the purpose of use of the optical dual Fabry-Perot interferometer film 1000 according to an embodiment of the present invention, and may be controlled according to the thickness of the first cavity layer 1300. As a specific example, as shown in FIG. 6, when the thickness of the first cavity layer 1300 is set so that the first preset wavelength of primary resonance is 700 nm, it can be seen that the spectral distribution of light transmitted through the first cavity layer 1300 has maximum transparency around 700 nm, which is the first preset wavelength.

According to one embodiment, the thickness of the first cavity region may be from 20 nm to 250 nm.

According to one embodiment, the spectral distribution of light transmitted to the second cavity layer 1500 may be controlled depending on the thickness of the first cavity layer 1300.

According to one embodiment, the first cavity layer 1300 may include a dielectric material that is transparent and has low light loss. For example, the dielectric material may include at least one inorganic substance of SiNₓ, Al₂O₃, SiO₂, HfO₂, WO₃, TiO₂, MoO₃, ZnO, Ta₂O₅, V₂O₅, LiF, and ZnS or at least one organic substance of PVP, PVC, PI, PMMA, NPB, TCTA, and TPBi, without being limited thereto.

The second reflection layer 1400 (reflector 2) may be a translucent metal thin film formed on the upper portion of the first cavity layer 1300, i.e., between the first cavity layer 1300 and the second cavity layer 1500.

According to one embodiment, the second reflection layer may be a metal thin film having a thickness of 1 nm to 35 nm.

According to one embodiment, the metal thin film may include at least one of gold (Au), silver (Ag), aluminum (Al), tungsten (W), and molybdenum (Mo).

According to one embodiment, the metal thin film may include at least one of alloy materials of gold, silver, and aluminum.

The second cavity layer 1500 (external cavity) may be formed on the upper portion of the second reflection layer 1400, i.e., between the second reflection layer 1400 and the third reflection layer 1600.

According to one embodiment, the second cavity layer 1500 may include a dielectric material that is transparent and has low light loss. For example, the dielectric material may include at least one inorganic substance of SiNₓ, Al₂O₃, SiO₂, HfO₂, WO₃, TiO₂, MoO₃, ZnO, Ta₂O₅, V₂O₅, LiF, and ZnS or at least one organic substance of PVP, PVC, PI, PMMA, NPB, TCTA, and TPBi, without being limited thereto.

According to one embodiment, the second cavity layer 1500 may cause a high-order (2nd, 3rd, 4th . . . ) resonance phenomenon in the second preset wavelength band. That is, in the second cavity layer 1500, light transmitted through the second anti-reflection layer 1700 to the second cavity layer 1500 is reflected multiple times by the second reflection layer 1400 and the third reflection layer 1600, so that high-order resonance may occur. At this time, the resonance order of the high-order resonance phenomenon occurring in the second cavity layer 1500 may be adjusted according to the thickness of the second cavity layer 1500. For example, as the thickness of the second cavity layer 1500 increases, the resonance order may increase. That is, light that has undergone a primary resonance in the first cavity layer 1300 experiences a secondary or higher-order resonance in the second cavity layer 1500.

According to one embodiment, the second preset wavelength band may be determined according to the purpose of use of the optical dual Fabry-Perot interferometer film 1000 according to an embodiment of the present invention, and may be controlled according to the thickness of the second cavity layer 1500. As a specific example, in FIG. 6, when the thickness of the second cavity layer 1500 is set so that the second preset wavelength of high-order resonance is 630 nm, light transmitted through the second cavity layer 1500 has a transmission spectrum with peaks in wavelength bands including 630 nm, 540 nm, and 460 nm.

According to one embodiment, the thickness of the second cavity region may be 200 nm to 1000 nm.

According to one embodiment, the peak position and color purity of a specific resonance wavelength of light transmitted through the second cavity layer 1500 may be adjusted depending on the thickness of the second cavity layer 1500. That is, depending on the thickness of the second cavity layer 1500, the width of each RGB color spectrum may be reduced, which increases color purity. That is, since the thicknesses of the first cavity layer 1300 and the second cavity layer 1500 may be adjusted to be the same for all RGB colors, when manufacturing an optical film, the patterning process performed to have cavity layers of different thicknesses for each RGB color is unnecessary. Accordingly, since the patterning process is not necessary when manufacturing the optical dual Fabry-Perot interferometer film 1000 according to the present invention, manufacturing time and manufacturing costs may be reduced. In addition, these characteristics may be advantageous in implementing large-area displays and lighting devices.

The third reflection layer 1600 (reflector 3) may be a translucent metal thin film formed on the upper portion of the second cavity layer 1500, i.e., between the second cavity layer 1500 and the second anti-reflection layer 1700.

According to one embodiment, the third reflection layer may be a metal thin film having a thickness of 1 nm to 35 nm.

According to one embodiment, the metal thin film may include at least one of gold (Au), silver (Ag), aluminum (Al), tungsten (W), and molybdenum (Mo).

According to one embodiment, the metal thin film may include at least one of alloy materials of gold, silver, and aluminum.

The second anti-reflection layer 1700 (anti-reflection film 2) may be formed on the upper portion of the third reflection layer 1600, i.e., between the third reflection layer 1600 and the substrate 1800. At this time, the second anti-reflection layer 1700 may affect reflectance occurring at the interface between the second cavity layer 1500 and the third reflection layer 1600 and the spectrum of light emitted to the outside through the optical dual Fabry-Perot interferometer film 1000.

According to one embodiment, the second anti-reflection layer 1700 may include a dielectric material that is transparent and has low light loss. For example, the dielectric material may include at least one inorganic substance of SiNₓ, Al₂O₃, SiO₂, HfO₂, WO₃, TiO₂, MoO₃, ZnO, Ta₂O₅, V₂O₅, LiF, and ZnS or at least one organic substance of PVP, PVC, PI, PMMA, NPB, TCTA, and TPBi, without being limited thereto.

The substrate 1800 may be formed on the upper portion of the second anti-reflection layer, and may include at least one of transparent substrates such as glass substrates, insulating polymer substrates, and semiconductor substrates.

According to one embodiment, the substrate 1800 may be a transparent and flexible substrate.

In addition, the resonance phenomenon of the first cavity layer 1300 and the second cavity layer 1500 may be controlled by adjusting the effective optical distance of the first cavity layer 1300 and the second cavity layer 1500.

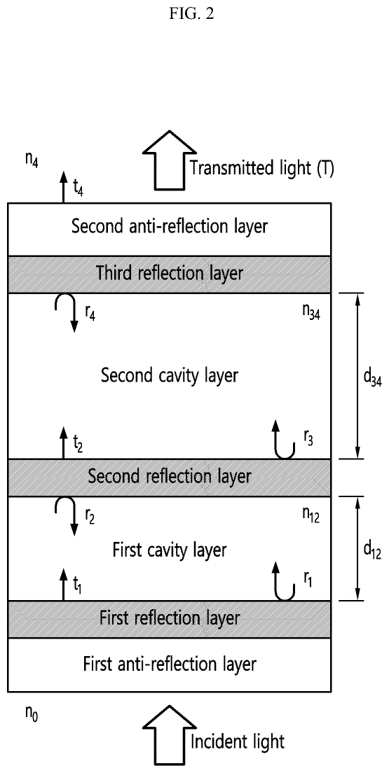

FIG. 2 is a diagram showing the parameters of an optical dual Fabry-Perot interferometer film according to an embodiment of the present invention.

Referring to FIG. 2, important parameters for designing the transmittance of the optical dual Fabry-Perot interferometer film are shown. Here, the transmittance of the optical dual Fabry-Perot interferometer film may be derived through Equation 1 below.

$$T = \frac{n \text{?}}{{n}_{0}} \times {\vert \text{?} \vert}^{2} \times \frac{{n}_{34}}{{n}_{12}} \times ( \frac{{\vert {t}_{2} \vert}^{2}}{1 + {R}_{12}^{2} - 2 R \text{?} cos Δ φ \text{?}} ) \times \frac{{n}_{4}}{{n}_{34}} \times ( \frac{{\vert {t}_{4} \vert}^{2}}{1 + R \text{?} - 2 R \text{?} cos Δ {φ}_{34}} )$$

$$\text{?} \text{indicates text missing or illegible when filed}$$

In Equation 1, n₀, n₁₂, n₃₄, and n₄ may represent the refractive index of each layer, t₁ may represent a transmission coefficient through the first anti-reflection layer 1100 and the first reflection layer 1200, t₂ may represent a transmission coefficient through the second reflection layer 1400, t₄ may represent a transmission coefficient through the third reflection layer 1600 and the second anti-reflection layer 1700, t₁ may represent a reflection coefficient between the first cavity layer 1300 and the first reflection layer 1200, t₂ may represent a reflection coefficient between the first cavity layer 1300 and the second reflection layer 1400, t₃ may represent a reflection coefficient between the second cavity layer 1500 and the second reflection layer 1400, t₄ may represent a reflection coefficient between the second cavity layer 1500 and the third reflection layer 1600, R₁₂ may represent |r₁r₂|, R₃₄ may represent [r₃,r₄], Δϕ₁₂ may represent a phase change occurring inside the first cavity layer 1300, and may represent a phase change occurring inside the second cavity layer 1500. Equation 1 may be expressed as multiplication of transmittance of light transmitted into the cavity first layer 1300 through the first reflection layer 1200, the Fabry-Perot factor of the first cavity layer 1300, and the Fabry-Perot factor of the second cavity layer 1500.

An equation that satisfies the constructive interference conditions of 4012 may be expressed as Equation 2 below.

$$Δ {φ}_{12} = - {φ}_{1} - {φ}_{2} + 2 {n}_{12} {d}_{12} {k}_{0} = 2 m π ( m = 0 ) \qquad [ Equation 2 ]$$

Equation 2 indicates that constructive interference occurs within the first cavity layer 1300. When m=0, a primary resonance mode may be exhibited in a specific wavelength band. ϕ₁ may represent a phase change occurring between the first cavity layer 1300 and the first reflection layer 1200, ϕ₂ may represent a phase change occurring between the first cavity layer 1300 and the second reflection layer 1400, and the resonance wavelength may be expressed by adjusting the thickness (d₁₂) of the first cavity layer 1300. This may be related to the spectral distribution of light transmitted to the outside through the optical dual Fabry-Perot interferometer film 1000.

An equation that satisfies the constructive interference conditions of Δϕ₃₄ may be expressed as Equation 3 below.

$$Δ {φ}_{34} = - {φ}_{3} - {φ}_{4} - 2 {n}_{34} {d}_{34} {k}_{0} = 2 m π ( m = 1 , 2 , 3 , … ) \qquad [ Equation 3 ]$$

Equation 3 indicates that constructive interference occurs within the second cavity layer 1500, and high-order resonance modes (m=1, 2, 3, *?*?*) may be exhibited in certain wavelength bands. ϕ₃ may represent a phase change occurring between the second cavity layer 1500 and the second reflection layer 1400, ϕ₄ may represent a phase change occurring between the second cavity layer 1500 and the third reflection layer 1600, and multiple resonance wavelengths may be exhibited by adjusting the thickness (d₃₄) of the second cavity layer 1500. This may be related to the peak positions of multiple resonance wavelength bands of light transmitted to the outside through the optical dual Fabry-Perot interferometer film 1000 and the improvement of color purity in each wavelength band.

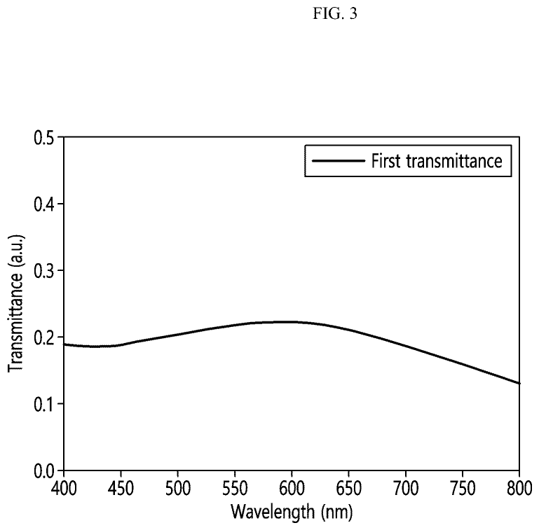

FIG. 3 is a diagram showing the transmittance of light transmitted to the first cavity layer through the first reflection layer 1200 calculated according to an embodiment of the present invention.

The transmittance of light shown in FIG. 3 may be expressed as Equation 4 below.

$$T = \frac{{n}_{12}}{{n}_{0}} \times {\vert {t}_{1} \vert}^{2} \qquad [ Equation 4 ]$$

The spectrum of light calculated using Equation 4 in FIG. 3 may be adjusted by the thickness of the transparent and low-light-loss dielectric materials of the first anti-reflection layer 1100, and may be adjusted by the translucent metal thin film and thickness of the first reflective layer 1200. In addition, the spectrum may be adjusted by the refractive index of each layer. Here, the calculated transmittance may be defined as first transmittance. This allows the amount of light transmitted through the first anti-reflection layer 1100 to the first cavity layer 1300 to be controlled differently.

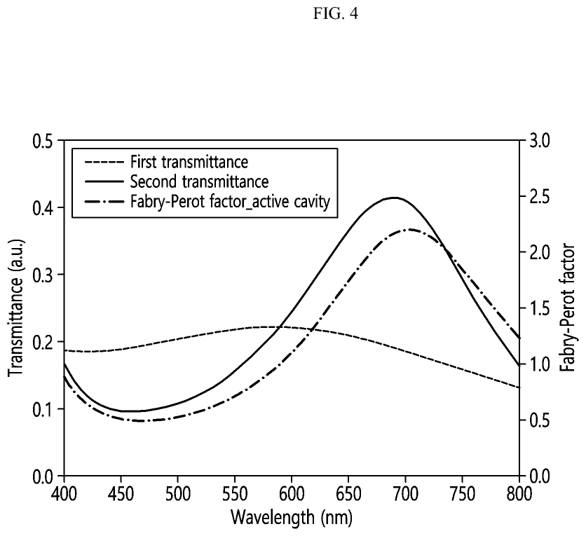

FIG. 4 is a diagram showing the Fabry-Perot factor of the first cavity layer 1300 and the transmittance of light transmitted to the second cavity layer 1500 through the second reflection layer 1400 calculated according to an embodiment of the present invention.

The Fabry-Perot factor of the first cavity layer 1300 shown in FIG. 4 and the transmittance of light transmitted through the second reflection layer 1400 to the second cavity layer 1500 may be expressed as Equation 5 below.

$$T = \frac{{n}_{12}}{{n}_{0}} \times {\vert {t}_{1} \vert}^{2} \times \frac{{n}_{34}}{{n}_{12}} \times ( \frac{{\vert {t}_{2} \vert}^{2}}{1 + {R}_{12}^{2} - 2 {R}_{12} cos Δ {φ}_{12}} ) \qquad [ Equation 5 ]$$

Second transmittance that is the transmittance of light transmitted to the second cavity layer 1500 through the second reflection layer 1400 calculated using Equation 5 in FIG. 4 may be expressed as multiplication of first transmittance and the Fabry-Perot factor (Fabry-Perot factor_active cavity) of the first cavity layer 1300. Due to a resonance phenomenon occurring within the first cavity layer 1300, a peak may appear in a specific wavelength band. This peak may appear in a resonance wavelength band that satisfies the primary resonance mode by adjusting the thickness of the first cavity layer 1300 in Equation 2. This may determine the spectral distribution of light transmitted through the optical dual Fabry-Perot interferometer film 1000.

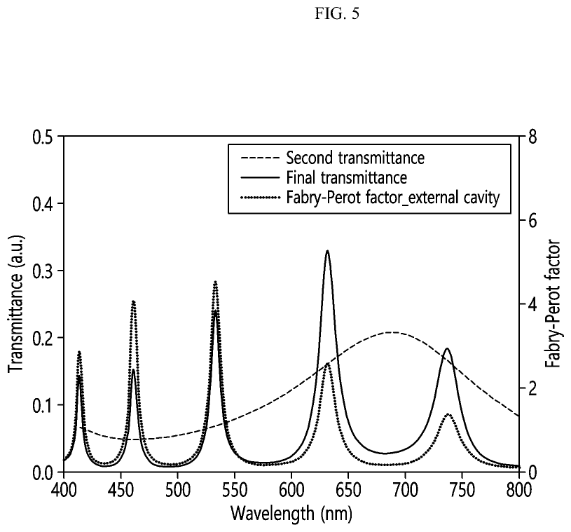

FIG. 5 is a diagram showing the Fabry-Perot factor of the second cavity layer 1500 and the transmittance of light transmitted to the outside through the third reflection layer 1600 calculated according to an embodiment of the present invention.

The Fabry-Perot factor of the second cavity layer 1500 shown in FIG. 5 and the transmittance of light transmitted to the outside through the third reflection layer 1600 may be expressed as Equation 1.

Final transmittance that is the transmittance of light transmitted to the outside through the third reflection layer 1600 calculated by Equation 1 in FIG. 5 may be expressed as multiplication of first transmittance, second transmittance, and the Fabry-Perot factor (Fabry-Perot factor_external cavity) of the second cavity layer 1500. Due to the resonance phenomenon occurring within the second cavity layer 1500, multiple peaks may appear in a specific wavelength band. These peaks may appear in the resonance wavelength band that satisfies the high-order resonance mode by adjusting the thickness of the second cavity layer 1500 in Equation 2. This may control the position and color purity of a specific resonance wavelength of light transmitted through the optical dual Fabry-Perot interferometer film 1000. Through Equation 1, the final transmittance may represent the transmittance of light transmitted through the optical dual Fabry-Perot interferometer film 1000.

FIG. 6 is a diagram showing the transmittance of an optical dual Fabry-Perot interferometer film using optical simulation according to an embodiment of the present invention.

Referring to FIG. 6, the spectral distribution of light transmitted through the first cavity layer 1300 (active cavity) of the optical dual Fabry-Perot interferometer film 1000 and light transmitted through the first cavity layer 1300 (active cavity) and the second cavity layer 1500 (external cavity) of the optical dual Fabry-Perot interferometer film 1000 are shown. The spectral distribution of this transmitted light was consistent with the transmittances calculated previously. The spectral distribution of light shown in FIG. 6 may be determined by the thickness of the first cavity layer 1300 of the optical dual Fabry-Perot interferometer film 1000. When light passing through the first cavity layer 1300 passes through the second cavity layer 1500, a spectral distribution with several peak values at a specific wavelength may be obtained. In FIG. 6, it can be seen that three peaks of red (R), green (G), and blue (B) occur. At this time, the transmittance of red is 0.65, the transmittance of green is 0.48, and the transmittance of blue is 0.25. The peak position of red is 630 nm, the peak position of green is 532 nm, and the peak position of blue is 460 nm. The full width at half maximum is 18 nm for red, 11 nm for green, and 10 nm for blue. Accordingly, in one embodiment of the present invention, with the optical dual Fabry-Perot interferometer film 1000, three peaks are observed simultaneously in the red, green, and blue wavelength bands, and color purity is improved due to the narrow full width at half maximum (FWHM).

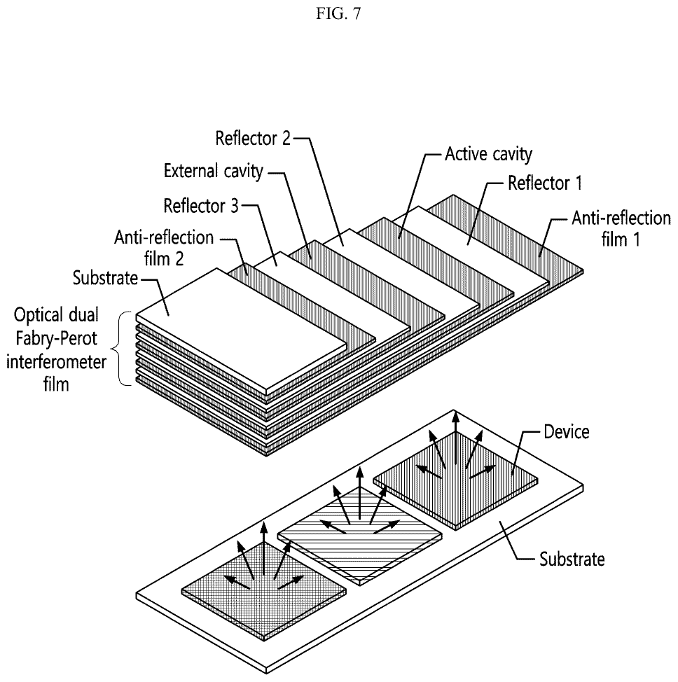

FIG. 7 is a diagram showing an example of an optical dual Fabry-Perot interferometer film according to an embodiment of the present invention.

Referring to FIG. 7, the optical dual Fabry-Perot interferometer film 1000 applied to a front-emitting light-emitting device is shown. In the optical dual Fabry-Perot interferometer film 1000 disposed on the upper portion of the front-emitting light-emitting device, the red, green, and blue light emitted from the front-emitting light-emitting device are transmitted through the first anti-reflection layer 1100 of the optical dual Fabry-Perot interferometer film 1000 to the first cavity layer 1300 and cause primary resonance in a specific wavelength band. The light that passes through the first cavity layer 1300 passes through the second cavity layer 1500 and high-order resonance occurs, allowing red, green, and blue light with increased color purity to be transmitted to the outside.

According to one embodiment, the front-emitting light-emitting device may include OLED, QLED, and uLED.

According to one embodiment, the front-emitting light-emitting device may be adhered to the lower portion of the first anti-reflection layer 1100 of the optical dual Fabry-Perot interferometer film 1000 using optical clear adhesive (OCA).

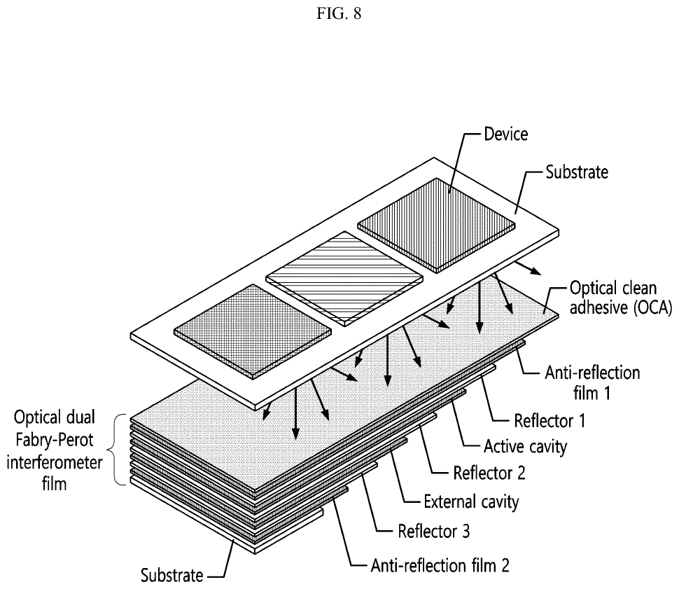

FIG. 8 is a diagram showing another example of an optical dual Fabry-Perot interferometer film according to an embodiment of the present invention.

Referring to FIG. 8, the optical dual Fabry-Perot interferometer film 1000 applied to a rear-emitting light-emitting device is shown. In the optical dual Fabry-Perot interferometer film 1000 disposed on the lower portion of the rear-emitting light-emitting device, the red, green, and blue light emitted from the rear-emitting light-emitting device are transmitted through the first anti-reflection layer 1100 of the optical dual Fabry-Perot interferometer film 1000 to the first cavity layer 1300 and cause primary resonance in a specific wavelength band. The light that passes through the first cavity layer 1300 passes through the second cavity layer 1500 and high-order resonance occurs, allowing red, green, and blue light with increased color purity to be transmitted to the outside.

According to one embodiment, the rear-emitting light-emitting device may include OLED, QLED, and uLED.

According to one embodiment, the rear-emitting light-emitting device may be adhered to the upper portion of the second anti-reflection layer 1700 of the optical dual Fabry-Perot interferometer film 1000 using optical clear adhesive (OCA).

Although the present invention has been described with reference to limited embodiments and drawings, it should be understood by those skilled in the art that various changes and modifications may be made therein. For example, the described techniques may be performed in a different order than the described methods, and/or components of the described systems, structures, devices, circuits, etc., may be combined in a manner that is different from the described method, or appropriate results may be achieved even if replaced by other components or equivalents.

Therefore, other embodiments, other examples, and equivalents to the claims are within the scope of the following claims.

1. An optical dual Fabry-Perot interferometer film, comprising:
a first anti-reflection layer;
a second anti-reflection layer formed on an upper portion of the first anti-reflection layer; and
first and second cavity regions formed between the first anti-reflection layer and the second anti-reflection layer.

2. The optical dual Fabry-Perot interferometer film according to claim 1, comprising:
a first reflection layer formed on an upper portion of the first anti-reflection layer;
a second reflection layer formed on an upper portion of the first reflection layer; and
a third reflection layer formed between the second reflection layer and the second anti-reflection layer,
wherein the first cavity region is the first cavity region formed between the first reflection layer and the second reflection layer, and
the second cavity region is the second cavity region formed between the second reflection layer and the third reflection layer.

3. The optical dual Fabry-Perot interferometer film according to claim 1, wherein the first cavity region generates primary resonance at a first preset wavelength band of light incident on the first cavity region, and
the second cavity region generates high-order resonance at a second preset wavelength band of light incident on the second cavity region.

4. The optical dual Fabry-Perot interferometer film according to claim 3, wherein a resonance order of the high-order resonance in the second cavity region is determined by a thickness of the second cavity region.

5. The optical dual Fabry-Perot interferometer film according to claim 1, wherein, depending on a thickness of the first cavity region, a spectral distribution of light transmitted through the optical dual Fabry-Perot interferometer film is determined.

6. The optical dual Fabry-Perot interferometer film according to claim 2, wherein a thickness of the first cavity region is 20 nm to 250 nm.

7. The optical dual Fabry-Perot interferometer film according to claim 1, wherein peak positions of red, green, and blue resonance wavelengths of light transmitted through the optical dual Fabry-Perot interferometer film and color purity at each are determined by a thickness of the second cavity region.

8. The optical dual Fabry-Perot interferometer film according to claim 2, wherein a thickness of the second cavity region is 200 nm to 1000 nm.

9. The optical dual Fabry-Perot interferometer film according to claim 3, wherein at least one of the first anti-reflection layer, the second anti-reflection layer, the first cavity region, and the second cavity region comprises a dielectric material.

10. The optical dual Fabry-Perot interferometer film according to claim 7, wherein the dielectric material is at least one inorganic substance of SiNₓ, Al₂O₃, SiO₂, HfO₂, WO₃, TiO₂, MoO₃, ZnO, Ta₂O₅, V₂O₅, LiF, and ZnS or at least one organic substance of PVP, PVC, PI, PMMA, NPB, TCTA, and TPBi.

11. The optical dual Fabry-Perot interferometer film according to claim 7, wherein the dielectric material is transparent.

12. The optical dual Fabry-Perot interferometer film according to claim 2, wherein at least one of the first reflection layer, the second reflection layer, and the third reflection layer is formed as a translucent reflector.

13. The optical dual Fabry-Perot interferometer film according to claim 12, wherein the reflector is formed using a metal thin film.

14. The optical dual Fabry-Perot interferometer film according to claim 13, wherein a thickness of the at least one metal thin film of the first reflection layer, the second reflection layer, and the third reflection layer is 1 nm to 35 nm.

15. The optical dual Fabry-Perot interferometer film according to claim 13, wherein the metal thin film comprises at least one of gold (Au), silver (Ag), aluminum (Al), tungsten (W), and molybdenum (Mo).

16. The optical dual Fabry-Perot interferometer film according to claim 11, wherein the metal thin film comprises at least one of alloy materials of gold, silver, and aluminum.

17. The optical dual Fabry-Perot interferometer film according to claim 1, further comprising a substrate formed on an upper portion of the second anti-reflection layer.

18. The optical dual Fabry-Perot interferometer film according to claim 17, wherein the substrate may be at least one of glass substrates, insulating polymer substrates, semiconductor substrates, and transparent substrates.

19. The optical dual Fabry-Perot interferometer film according to claim 15, wherein the substrate is a transparent and flexible substrate.

20. An optical dual Fabry-Perot interferometer film, comprising:
a first anti-reflection layer;
a first reflection layer formed on an upper portion of the first anti-reflection layer;
a second reflection layer formed on an upper portion of the first reflection layer;
a first cavity layer formed between the first reflection layer and the second reflection layer;
a third reflection layer formed on an upper portion of the second reflection layer;
a second cavity layer formed between the second reflection layer and the third reflection layer; and
a second anti-reflection layer formed on an upper portion of the third reflection layer.

21.-26. (canceled)
